(19) United States
(12) Patent Application Publication
(10) Pub. No.: US 2006/0112947 A1
(43) Pub. Date: Jun. 1, 2006

(54) Steam cooker with moving steam delivery member

(76) Inventors: Atul Saksena, Troy, OH (US); Magdy Albert, Sleepy Hollow, IL (US)

Correspondence Address: THOMPSON HINE LLP, P.O Box 8801, DAYTON, OH, 45401-8801, US

(21) Appl. No.: 10/999,097

(22) Filed: Nov. 29, 2004

(51) Int. Cl. A21B 1/08

(52) U.S. Cl. 126/20

(57) ABSTRACT

A steam cooker includes a steam cooking chamber configured to receive steam during a cooking operation. A steam delivery member located to deliver steam into the steam cooking chamber has a steam outlet and the steam delivery member moves.

### TECHNICAL FIELD

The present application relates to steam cookers and more particularly to a steam cooker including a steam distribution device.

### BACKGROUND

Steam cookers have been successfully employed by restaurants, hospitals and other food service operations to prepare quickly and conveniently large quantities of food. Typically, steam is generated in a steam generator and the generated steam is delivered into the cooking chamber of the steam cooker through a fixed outlet nozzle. It would be desirable to provide a steam cooker in which steam is delivered into the steam cooking chamber in a manner to provide an effective distribution of steam throughout the chamber.

### SUMMARY

In an aspect, a steam cooker includes a steam cooking chamber with an access opening and an associated door moveable between open and closed positions. A steam distribution device is positioned for directing steam into the steam cooking chamber during a cooking operation. The steam distribution device includes a movable steam delivery member having a steam passageway extending therethrough to a steam outlet. During a steam cooking operation, steam is delivered to the steam cooking chamber via the steam passageway and steam outlet and the movable steam delivery member and its steam outlet move thereby varying the direction at which steam enters the steam cooking chamber.

In another aspect, a steam cooker includes a steam cooking chamber configured to receive generated steam during a cooking operation and a steam delivery member located in the steam cooking chamber and having a steam passageway extending from a steam inlet for receiving steam to a steam outlet for egress of steam to the cooking chamber. The steam delivery member is mounted for movement under forces generated by steam exiting the steam outlet.

In another aspect, a method of distributing steam in a cooking chamber of a steam cooker is provided. The method includes routing steam to a steam distribution device comprising a movable steam delivery member, the steam distribution device located in a cooking chamber of a steam cooker. Using the steam, driving the movable steam delivery member, the movable steam delivery member having a steam outlet through which the steam exits as the movable steam delivery member moves. The position of the steam outlet within the cooking chamber varying with movement of the moveable steam delivery member.

### BRIEF DESCRIPTION OF DRAWINGS

FIG. 1 is a perspective view of a steam cooking chamber including an embodiment of a steam delivery device;

FIG. 2 is a side view of the steam delivery device of FIG. 1;

FIG. 3 is an exploded view of the steam delivery device of FIG. 2;

FIG. 4 is a section view of an embodiment of an inner axial member of the steam delivery device along line 4-4 of FIG. 3;

FIG. 5 is a section view of an embodiment of a mounting member of the steam delivery device along line 5-5 of FIG. 3;

FIGS. 6 and 7 are end and perspective views, respectively, of an embodiment of a moveable steam delivery member of the steam delivery device of FIG. 3;

FIG. 8 is a section view of the steam delivery member along line 8-8 of FIG. 3;

FIG. 9 is a section view of the steam delivery device along line 9-9 of FIG. 2;

FIG. 10 is a side view of the steam delivery device of FIG. 2 connected at a wall; and

FIG. 11 is a front view of another embodiment of a steam delivery device including moveable steam delivery member.

### DESCRIPTION

Referring to FIG. 1, a steam cooking chamber 10 of a steam cooker is shown. The steam cooking chamber 10 includes a housing 12 and an access opening 14 providing access to the cooking chamber 10. To close the access opening 14, a door 16 is hingedly attached to the housing 12. The housing 12 includes opposing side walls 18 and 20, opposing top and bottom walls 22 and 24 extending between the side walls and a rear wall 26 extending between the top, bottom and sidewalls at the rear of the cooking chamber 10.

The cooking chamber 10 is connected to a steam source (not shown), such as a steam generator, that is capable of providing steam for use during a cooking operation. The generated steam is outlet into the cooking chamber 10 using a steam delivery device 30 that may be attached within the cooking chamber at one of the walls 18, 20, 22, 24 or 26. As shown, the delivery device is attached at the sidewall 20, but the delivery device may be attached at any of the other walls. In some embodiments, more than one steam delivery device 30 may be attached within the cooking chamber 10, e.g., at the same wall or at differing walls. As will be described in greater detail below, the delivery device 30 includes a moveable steam delivery member 32 that is mounted for movement (e.g., in the direction of arrow 34) within the cooking chamber 10 as steam is delivered to the cooking chamber. Forces generated by the steam cause the movable steam delivery member and its steam outlet to move thereby varying the direction at which steam enters the steam cooking chamber. The changing position of the steam outlet(s), and thus changing direction at which steam enters the chamber can, in some applications, reduce or eliminate the set up of permanent flow paths in the steam cooking chamber that might cause steam to be concentrated only in certain parts of the chamber.

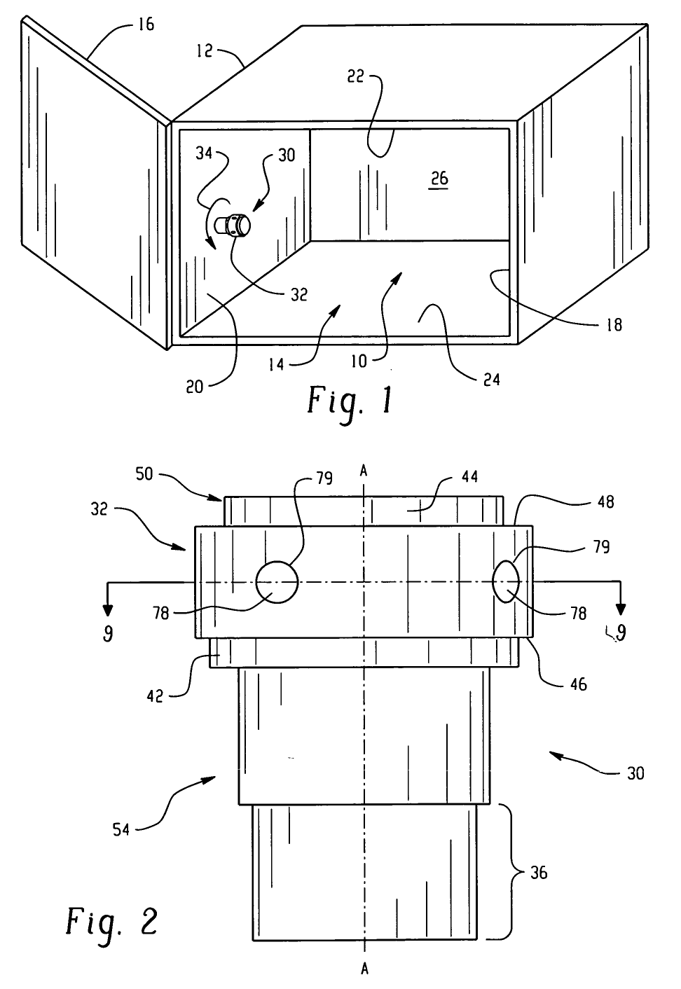

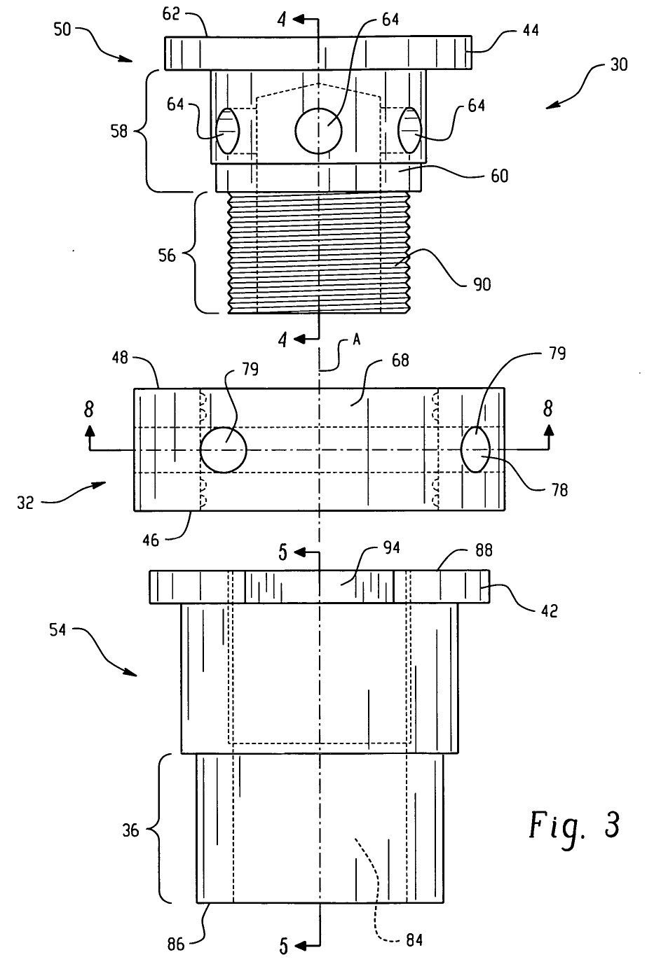

Referring to FIGS. 2 and 3, where the steam delivery device is shown in assembled and exploded views respectively, the illustrated steam delivery device 30 includes a radially inner axial member 50 that fixedly connects to a mounting member 54 forming an axis A. The steam delivery member 32, here in the form of a rotatable hub, is configured to receive the inner axial member 50 in a manner to allow the steam delivery member to rotate relative to the axial and mounting members 50 and 54 about the axis A. Referring particularly to FIG. 2, the steam delivery member 32 is sandwiched between flanges 42 and 44 that are positioned at opposite ends 46 and 48 of the steam delivery member. The flanges 42 and 44 are used by the steam delivery device to locate the steam delivery member axially. For use in dispensing steam, steam delivery member 32 includes a steam outlet 79 located at the periphery of the steam delivery member and an associated steam passageway 78 extending inwardly from the steam delivery member's periphery.

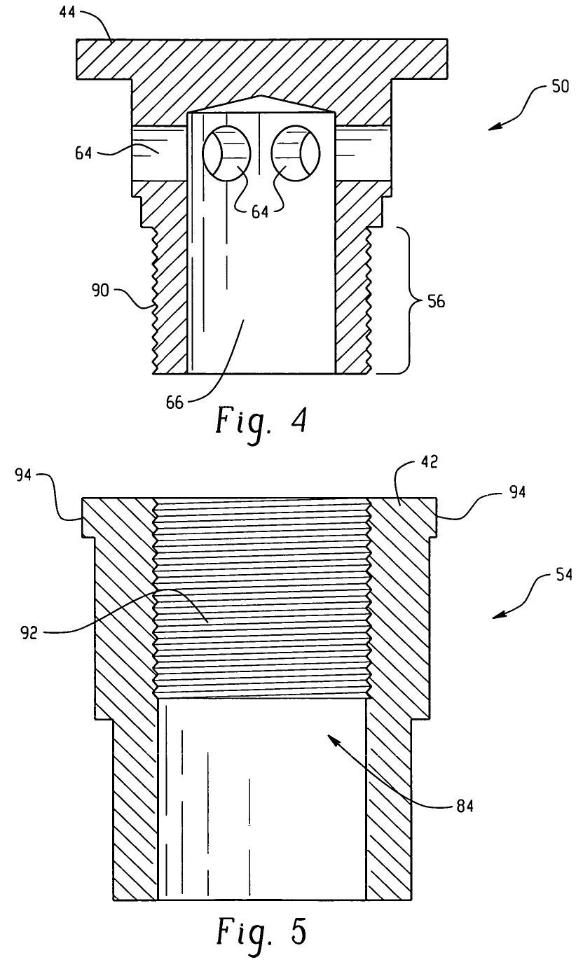

Referring now to FIG. 3, the illustrated inner axial member 50 includes a bearing portion 58 having an outer bearing surface 60 about which the steam delivery member can rotate and a connecting portion 56 of a reduced outer diameter for connecting to the mounting member 54. Extending outwardly from the outer bearing surface 60 at an end 62 of the inner axial member 50 is the flange 44. A circumferential array of steam ports 64 is located at the bearing portion 58 and adjacent the flange 44 with each steam port of the array spaced apart from an adjacent steam port about the inner axial member's periphery. The exact number and location of the steam ports might be varied. As can be seen in FIG. 4, the steam ports are in communication with an axial steam passageway 66 extending only partially through the inner axial member 50.

Referring back to FIG. 3, the illustrated mounting member 54 includes a mounting portion 36 of reduced outer diameter for mounting the steam delivery member 30 within the cooking chamber 10 (e.g., using a threaded connection), flange 42 and an opening 84 extending between ends 86, 88 of the mounting member. Referring also to FIG. 5, opening 84 is sized to receive and connect to the connecting portion 56 of the inner axial member 50 so that steam can be delivered through the axial opening 84 to the axial steam passageway 66. In some embodiments, the inner axial member 50 and mounting member 54 are connected via a mating threaded connection with the inner axial member having a threaded outer surface 90 (FIG. 4) and the mounting member having a corresponding threaded inner surface 92. Other connecting structure is possible, such as a clamp, friction or press fit, etc. The connection between the mounting and axial members 50 and 54 can form an air-tight and/or water-tight seal to inhibit steam leak between the members during use. To aid in grasping and rotating the mounting member 54, e.g., to aid a user in fastening and unfastening the steam delivery device from within the cooking chamber 10, the flange 42 includes flattened portions 94 (FIG. 3).

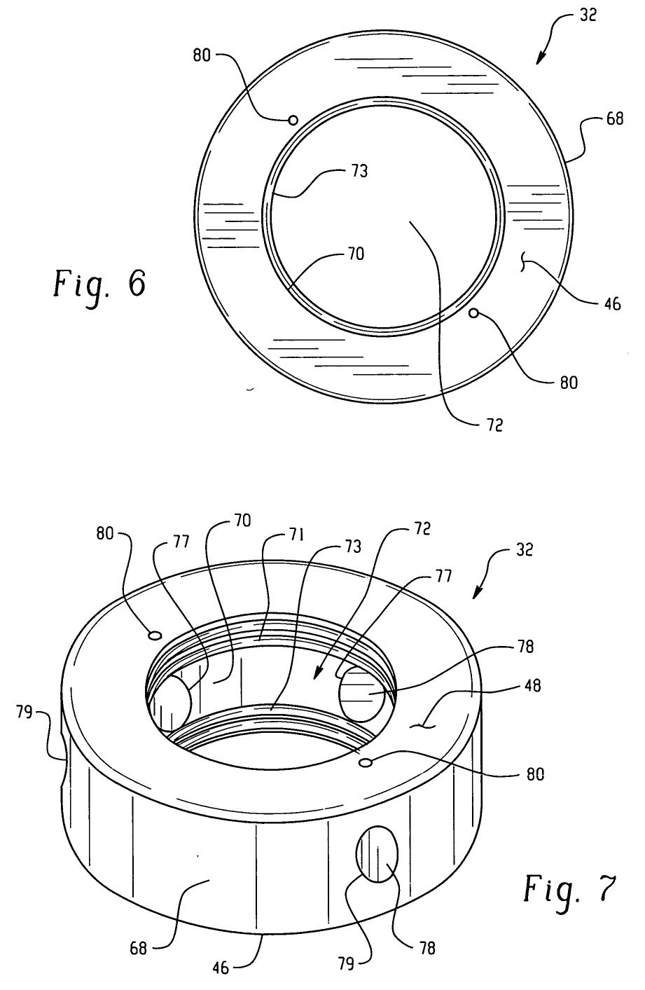

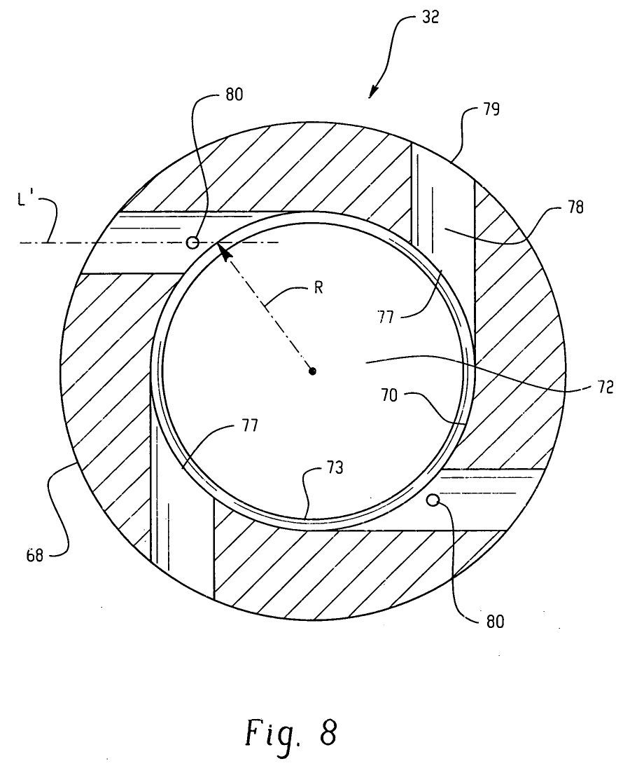

Referring again to FIG. 3 and also to FIGS. 6-8, the illustrated steam delivery member 32 has an outer surface 68, an inner surface 70 and a bore 72 extending between opposite ends 46 and 48 of the steam delivery member that is sized to receive the bearing portion 58 of the inner axial member 50. To assist in stabilizing the steam delivery member 32 during use, at each end 46 and 48 of the steam delivery member, a pair of stabilizing ports 80 each in communication with an associated steam passageway 78 (see FIG. 8) may be provided. The stabilizing ports 80 allow an amount of steam to impinge upon the flanges 42 and 44 (FIG. 2), e.g., to aid in locating the steam delivery member axially between the two flanges and to reduce frictional sliding of the steam delivery member against the flanges. The inner surface 70 also includes ribbed portions 71 and 73 that can reduce the sliding friction between the inner and bearing surfaces. Referring particularly to FIGS. 7 and 8, the steam passageways 78 extend through the steam delivery member 32 from the inner surface 70 at a steam inlet 77 to the outer surface 68 at the steam outlet 79. In the illustrated embodiment, each steam passageway 78 has a central axis L′ that extends through the steam delivery member in a direction offset at an angle from the radial direction indicated by radius R so that the force of steam exiting the passageways causes rotational movement of the steam delivery member 32.

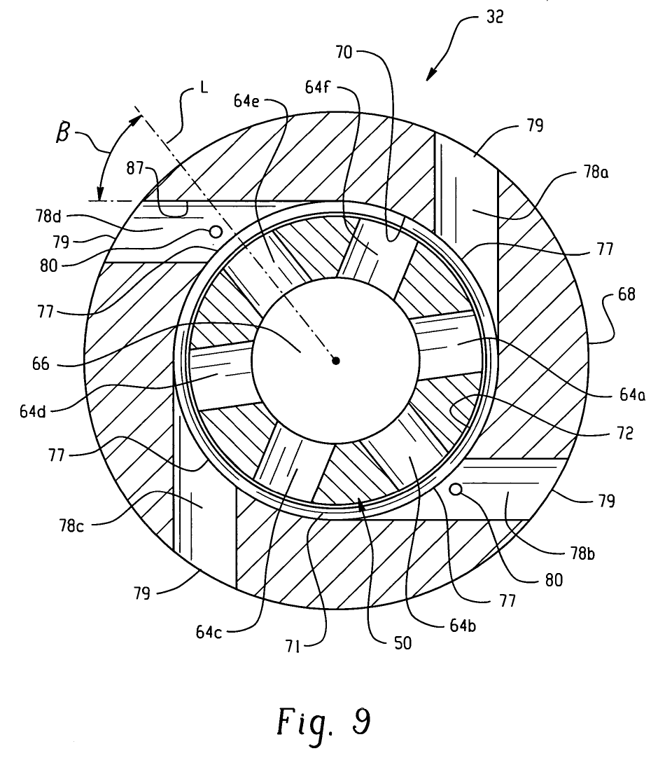

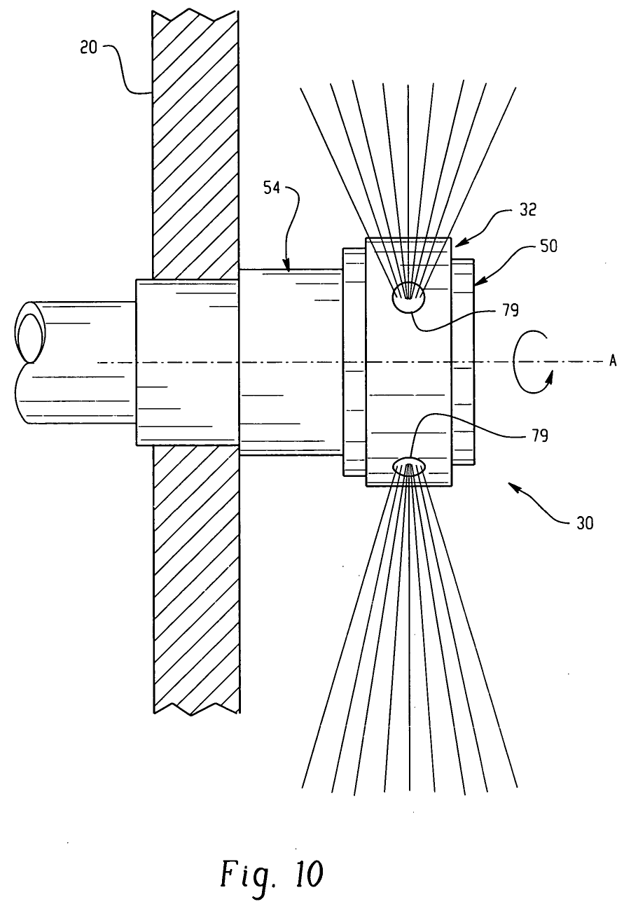

As assembled, referring now to FIG. 9, the steam ports 64 and steam passageways 78 are aligned axially such that steam traveling from the mounting member 54 to the inner axial member 50, through the steam ports 64, through the passageways 78 and exiting the outlets 79 can impart motion to the steam delivery member 32. Because steam exits the outlets at an angle relative to the radial direction, the reactive force on member 32 causes its rotation. The angular offset between steam ports 64 and passageways 78 can also aid in initiating rotation of the member 32. To illustrate, referring particularly to steam passageway 78d and steam port 64e, when a steam passageway is in communication with an associated steam port, the steam port 64e has a central axis L that intersects a sidewall 87 of the steam passageway 78d at an angle β. By providing the relative angle β between the sidewall 87 and the axis L, steam exiting the steam port 64 can collide against the sidewall to impart forces to the steam delivery member 32, which, depending at least in part on the flow rate of the steam, can cause the steam delivery member to rotate.

As can be seen by FIG. 9, in the illustrated embodiment the inner axial member 50 has a greater number of steam ports 64a-64f (e.g., six) than the number of steam passageways 78a-78d (e.g., four) extending through the steam delivery member 32. Other configurations are possible, such as the inner axial member 50 having less than or the same number of steam ports 64 compared to the number of steam passageways 68. In the illustrated embodiment, each steam port 64 is capable of communicating with each steam inlet 77 and associated steam passageway 78 as the steam delivery member 32 rotates.

Steam exiting the steam ports 64 may also enter the annular space between member 32 and member 50 to create a steam bearing that reduces frictional forces between the inner surface of member 32 and the outer surface of member 50, thereby facilitating the rotation of member 32, even when the steam is delivered at relatively low pressure (e.g., such as about 2-3 psi or less at the steam outlets 79). Additionally, when steam is being delivered at low pressures the use of the moving steam delivery members to provide effective distribution in the steaming chamber can enable the use of a reduced number of steam nozzles, thereby providing a greater steam exit speed from the steam outlets of the nozzles. Depending upon the available steam pressure, the number of steam outlet ports can be varied as desired to achieve suitable movement of the steam delivery member.

FIG. 10 shows the steam delivery device 30 connected to a steam source at wall 20 of the cooking chamber. As described above, the steam delivery device 30 is capable of distributing steam generated at the steam source and delivered to the cooking chamber while the steam delivery member 32 rotates about axis A and the steam 94 exits the steam outlets 79. In some embodiments, as attached to the wall 20 of the cooking chamber, each point on the steam delivery member 32 rotates in a plane substantially parallel to a plane defined by the associated wall with the axis of rotation A extending substantially perpendicular to both planes. In some embodiments, the steam delivery member 32 is located outwardly beyond the wall such that steam can be delivered relatively unimpeded along the surface of the wall 20. Alternatively, the steam delivery member 32 may be located in a recess formed in the wall. It is also possible that a false wall (e.g., in the form of a wall with multiple openings or a metal screen) might be placed over such a recess to prevent contact with the steam delivery unit while still allowing the steam to enter the cooking chamber. In some embodiments, a deflecting member (not shown) may be placed adjacent the steam delivery device that can be used to redirect the steam delivered from the steam delivery member outwardly from the wall, for example, toward the center of the cooking chamber. FIG. 12 shows a schematic front elevation in which the steam cooking chamber 10 includes an upper and lower rack supporting food product to be steamed within the chamber and schematically showing a source of steam 200 alongside the chamber. Steam source 200 could be, for example, a boiler of any suitable configuration, including a boiler providing steam at a temperature of around 212° F. or a boiler configured to provide superheated steam at temperatures upward of 220° F.

The inner axial member 50, steam delivery member 32 and mounting member 54 can be formed of any suitable material, including stainless steel and brass. Any suitable method can be used to form the inner axial member 50, steam delivery member 32 and mounting member 54, such as casting and/or machining.

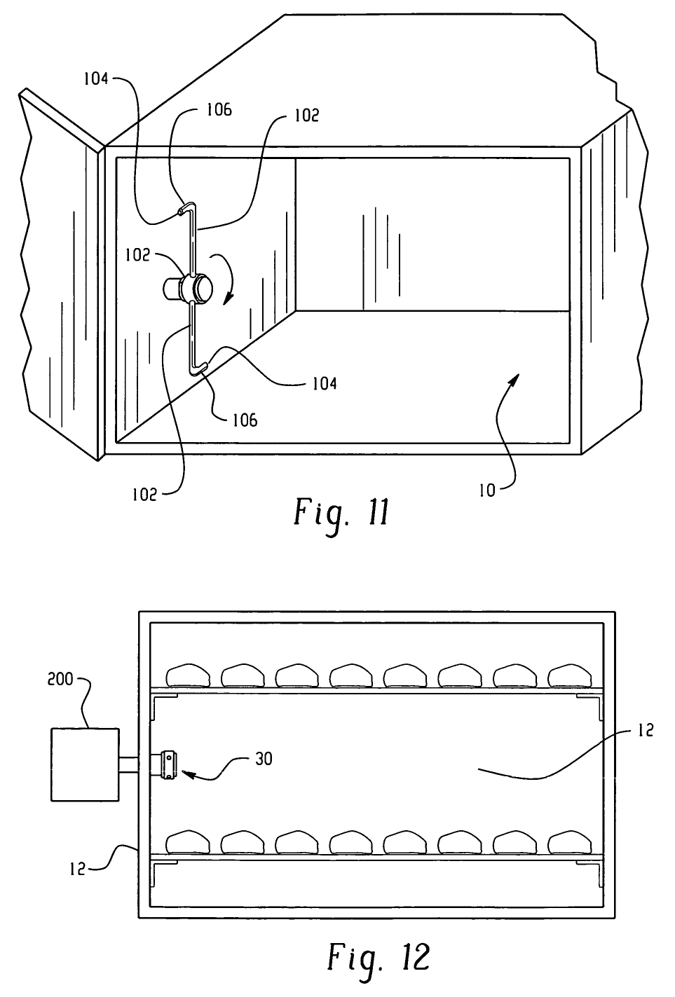

It is to be clearly understood that the above description is intended by way of illustration and example only and is not intended to be taken by way of limitation, and that changes and modifications are possible. While the use of a rotatable hub is primarily described, devices that utilize other moveable steam delivery configurations (including configurations that do not necessarily rotate) can be provided. Reference is made to FIG. 11 in which a cooking chamber 10 includes a moveable steam delivery member 100 that includes a pair of arms 102 and steam outlets 104 located at the ends 106 of the arms. The arms 102 and associated steam passageways (not shown) are shaped such that the moveable steam delivery member 100 rotates due to the steam imparting forces to cause the moveable steam delivery member to move as steam travels through the arms and out the steam outlets 104. Accordingly, other embodiments are contemplated. Other modifications and changes could be made without departing from the scope of this application as expressed by any claims now included or hereafter added.

What is claimed is:

1. A steam cooker, comprising:
a steam cooking chamber including an access opening with an associated door moveable between open and closed positions; and
a steam distribution device positioned for directing steam into the steam cooking chamber during a cooking operation, the steam distribution device comprising a movable steam delivery member having a steam passageway extending therethrough to a steam outlet, during a steam cooking operation steam is delivered to the steam cooking chamber via the steam passageway and steam outlet and the movable steam delivery member and its steam outlet move thereby varying the direction at which steam enters the steam cooking chamber.

2. The steam cooker of claim 1 wherein forces generated by the steam cause the movable steam delivery member to move.

3. The steam cooker of claim 2 wherein a pressure of steam delivered through the steam passageway is less than 2 psi.

4. The steam cooker of claim 2, wherein the movable steam delivery member has multiple steam passageways extending therethrough to respective steam outlets.

5. The steam cooker of claim 1, wherein the movable steam delivery member is a rotatable hub having an axial bore extending between a first end surface and a second, opposite end surface, the steam passageway in communication with the axial bore and extending outwardly to an outer surface of the rotatable hub.

6. The steam cooker of claim 5 further comprising an inner axial member extending through the bore of the rotatable hub, the rotatable hub rotatable about the inner axial member, the inner axial member having a axial steam passageway extending axially therethrough and an outlet port extending from the axial steam passageway to an outer surface of the inner axial member, the outlet port capable of communicating with the steam passageway of the rotatable hub.

7. The steam cooker of claim 6, wherein the inner axial member includes multiple outlet ports extending from the axial steam passageway to the outer surface of the inner axial member, the multiple outlet ports being aligned about the inner axial member's periphery in a circumferential array such that the outlet ports are each capable of communicating with the steam passageway of the rotatable hub as the rotatable hub rotates relative to the inner axial member.

8. The steam cooker of claim 7, wherein the rotatable hub has multiple steam passageways in communication with the bore and extending through the rotatable hub to respective steam outlets.

9. The steam cooker of claim 6 further comprising a base member connected to the inner axial member.

10. The steam cooker of claim 9, wherein the base member includes a flange extending outwardly from an outer surface of the base member, the flange capable of limiting axial movement of the rotating hub.

11. The steam cooker of claim 10, wherein the inner axial member includes a flange extending outwardly from the outer surface of the axial member, the rotatable hub located between the flange of the inner axial member and the flange of the base member.

12. The steam cooker of claim 10, wherein the rotatable hub includes a first stabilizing port extending from the steam passageway to the first end surface and a second stabilizing port extending from the steam passageway to the second end surface.

13. The steam cooker of claim 9, wherein the base member includes a threaded bore mated with a corresponding threaded outer surface of the inner axial member.

14. The steam cooker of claim 9, wherein the base member includes a steam path extending therethrough, the steam path in communication with the axial steam passageway of the inner axial member.

15. The steam cooker of claim 14, wherein the base member is connected to a wall of the cooking chamber.

16. The steam cooker of claim 1, wherein the movable steam delivery member is a rotatable hub having an axial bore the steam passageway in communication with the axial bore, the rotatable hub positioned on an inner axial member extending through the axial bore, the inner axial member having a steam path extending therethrough and an outlet port extending from the steam path to an outer surface of the inner axial member, steam is delivered through the steam path into a space between the inner axial member and the rotatable member to create a steam bearing.

17. The steam cooker of claim 16 wherein the rotatable hub is positioned between first and second spaced apart surfaces, a first stabilizing port outputs steam toward the first surface and a second stabilizing port outputs steam toward the second surface.

18. The steam cooker of claim 1, wherein the steam distribution device is located on a sidewall of the steam cooking chamber.

19. The steam cooker of claim 18, wherein the steam distribution device is located at one of a top wall or a rear wall of the steam cooking chamber.

20. The steam cooker of claim 1, further comprising a food product within the steam cooking chamber.

21. The steam cooker of claim 1 wherein the food product is located at multiple levels within the steam cooking chamber, including a level above the movable steam delivery member and a level below the movable steam delivery member.

22. A steam cooker, comprising:
a steam cooking chamber for receiving food products; and
a steam delivery member located in the steam cooking chamber and having a steam outlet for delivery of steam to the cooking chamber, the steam delivery member mounted for movement under forces generated by steam exiting the steam outlet.

23. The steam cooker of claim 21, wherein the steam delivery member has multiple steam outlets.

24. The steam cooker of claim 22 wherein the steam delivery member is mounted for rotation about another member, steam is delivered to create a steam bearing between the steam delivery member and the another member.

25. The steam cooker of claim 24 wherein the steam delivery member comprises an annular member and the another member is disposed through the annular member, the steam bearing is created between an inner surface of the annular member and an outer surface of the another member.

26. The steam cooker of claim 24, wherein the annular member is positioned between first and second spaced apart surfaces, a first stabilizing port of the annular member outputs steam toward the first surface and a second stabilizing port of the annular member outputs steam toward the second surface.

27. A method cooking a food product with a cooking chamber of a steam cooker, the method comprising:
routing steam to a steam distribution device comprising a movable steam delivery member, the steam distribution device located in the cooking chamber of the steam cooker; and
using the steam, driving the movable steam delivery member, the movable steam delivery member having a steam outlet through which the steam exits into the cooking chamber as the movable steam delivery member moves, the position of the steam outlet within the cooking chamber varying with movement of the moveable steam delivery member.
